(19) United States
(12) Patent Application Publication
(10) Pub. No.: US 2009/0083696 A1
(43) Pub. Date: Mar. 26, 2009

(54) APPARATUS, AND ASSOCIATED METHODOLOGY, FOR PLANNING, MODELING, AND MONITORING A DEVELOPMENT PROCESS

(75) Inventor: BRENT L. BLACKBURN, ALLEN, TX (US)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 11/861,439

(22) Filed: Sep. 26, 2007

(51) Int. Cl. G06F 9/44

(52) U.S. Cl. 717/104

(57) ABSTRACT

A tool and an associated methodology for planning, modeling, and monitoring a development project are provided. The tool includes a centrally-positioned data base, such as at an SQL Server. An optimized model of the development project is created, and updates are provided thereto, such as updates provided by project personnel working at remote sites. Due to the centralization of the data and quantitative mechanisms by which to report to, and update the contents of, the data base, an accurate plan and model of the development project is made, facilitating improved tracking of the progress of the development project.

The present invention relates generally to an apparatus and an integrated methodology by which to plan, design, build and modify an optimized manufacturing process for services-based products, such as a computer-service-based process.

A software application, Virtual Assembly Line for Unified Engineering (V.A.L.U.E.), is provided that enables the development and optimization of the manufacturing process, and permits ad hoc monitoring thereof for marketing, planning, and tracking purposes.

### BACKGROUND OF THE INVENTION

The collection, storage, and processing of data is pervasive throughout modern society. Many business, and other, activities are dependent upon the ready access to such data. With continued advancements in digital processing and computer storage technologies, new computer-based services become available with regularity. Improvements to existing computer-based services also are regularly provided.

Development of new computer-based services as well as upgrades, and refigurations, of existing computer-service systems are regularly carried out. Unlike conventional, assembly-line-created goods, however, tracking and monitoring the progress of work performed on the development of service based manufacturing processes are difficult to monitor. Computer-based services rely in large part on computer programs and software, which are not created using sequenced and conditionally-executed, manufacturing steps to yield predictable outcomes at predictable qualities, paces and costs. That is to say, the manufacturing processes by which computer-based services are created are not linked to automated or mechanized workflow systems that orchestrate the pace, sequencing and conditional execution of the manufacturing steps of hard goods. As a result, delivery of a computer-service-based system is sometimes unpredictably variable.

Planning for the new, upgraded, or reconfigured manufacturing process is typically, therefore, a difficult endeavor. And, correspondingly, monitoring and tracking the development of the new, upgraded, or reconfigured manufacturing process is also a difficult endeavor. Tasks are sometimes carried out by separate groups of developers, positioned at remote locations, sometimes operating at semi-autonomously. Tracking the status of the progress of the work is sometimes difficult accurately to assess due to the performance of the different development tasks at different locations, sometimes non-uniform reporting of the completion of the development tasks, etc.

That is to say, generally, existing, planning, modeling, and tracking of development of a manufacturing process of a service that is comprised of something other than mass-produced hard goods is difficult due to lack of standardization or consolidation at a centralized location. Computer service system development is typically formed of aggregations of lower-level tasks whose timely completion is essential to timely completion of the computer service system. Accurate tracking of the completion of the low-level tasks is essential to determine the timeliness of the overall development process.

As existing schemes suffer from various deficiencies, including those just-mentioned, an improved planning, modeling, and monitoring mechanism is needed.

It is in light of this background information related to the planning of development processes that the significant improvements of the present invention have evolved.

### SUMMARY OF THE INVENTION

The present invention, accordingly, advantageously provides apparatus including, e.g., a software application and an integrated methodology by which to plan, design, build and modify an optimized manufacturing process for services based products, such as a computer-service-system process in which engineering, and other, tasks are carried out pursuant to the development process, e.g., at disparate locations.

Through operation of an embodiment of the present invention, a manner is provided by which to enable the development and optimization of the manufacturing process that permits ad hoc monitoring thereof for marketing, planning, and tracking purposes. The optimized manufacturing process is maintained at a centralized location, and updated through a rigorous change management methodology. The optimized manufacturing process is, for instance used as the base process for creating uniquely customized computer based services. Additionally, this optimized manufacturing process is used for marketing, scheduling, planning, and work tracking.

Through operation of an embodiment of the present invention, a tool is provided that enables the creation of a virtual assembly line by which tasks are associated with underlying raw materials, labor, instructions, skills, standard, automation and test cases. These tasks are then categorized into groups, sequences and conditional execution to form the virtual assembly line. The assembly line is depicted as virtual in that the tool models the actual flows that occur throughout the various production facilities. Additionally, the tool enables extensive re-use of the engineering collateral that can be commonly used across various engineering organizations. As such, the tool “unifies” the engineering teams so that redundant engineering work can be eliminated. In consideration that the tool enables the creation of a virtual assembly line and unifies the various engineering teams, it has been named Virtual Assembly Line for Unified Engineering (V.A.L.U.E.)

In one aspect of the present invention, a data base is maintained at a centralized location. The data is stored, e.g., at a central data base, using a relational database management system, like Microsoft's SQL Server. The data is dynamically modified and configured based upon the specific needs of a virtual assembly line. The data administration capability is secured through a three tiered security construct using Role, Team or User credentials. The updates are provided, e.g., by developers, or other development-process personnel, working at remote locations. The updates include adding, modifying, deleting, sequencing, establishing conditional execution and providing status updates of development activities performed by the personnel. The updates are stored and managed within the relational database management system such that interaction between the data and the support personnel can be done in a real time and concurrent fashion.

In another aspect of the present invention, display information is generated during updating and browsing operation of the tool. The display information created during the update process provides status information relative to the nature of the update. The display information created during ad hoc browsing is relative to the content and status of the various virtual assembly line components. The data model depicts components of the tool and illustrates the hierarchy and manners in which the components are logically linked to one another. The data model and underlying security policies control the display information. This data model is visibly displayed within the tool and can be accessed from anywhere within the tool. Visibility to the underlying security policies are restricted to authorized users.

The display information also provides for the generation and display of a portfolio view of the virtual assembly line content. The portfolio view provides a sales-related view that identifies the virtual assembly line in terms of an offering, and packages, and features.

In another aspect of the present invention, the display information is usable to generate a delivery view of the virtual assembly line content. The delivery view provides a manufacturing view that depicts information associated with the grouping, sequencing and conditional execution of individual tasks. Additionally, the displayed information provides and-status on the individual tasks and their underlying components, thereby to provide an indication of progress towards completion of the development process and individual tasks thereof.

In another aspect of the present invention, the display information is provided to remote locations, such as responsive to requests for the information. Display information permitting generation of display of any of the data model, portfolio view, delivery view, or sub-views thereof is provided. The displays utilize information resulting from, or associated with, the modeling and monitoring of the virtual assembly line.

The virtual assembly line for unified engineering tool further provides change management control. That is to say, updating of the model is restricted. Restrictions are based, for instance, on the role, team, and user for which, or by which, the information is sourced. Role credentials, team credentials, and user credentials define a three-tiered security construct. Additionally, if the update information is related to a component for which updates are no longer required, such an update is not utilized.

In another aspect of the present invention, an architecture score card is provided. Assessment of technology-based raw materials is further provided to provide for a comparative analysis of the various raw materials, permitting selection to be made on a quantitative basis.

In another aspect of the present invention, release planning and management is provided. Display information is further provided that permits viewing of existing and future products and services in terms of their underlying reference architecture and chronological timeline of development.

In another aspect of the present invention, a workflow catalog is generated as a byproduct of operation of the tool. Data forming the workflow catalog is remotely accessible and usable by a workflow engine, such as a workflow engine positioned remote from the central location at which the tool, and its associated model of the virtual assembly line, is maintained.

A model of a virtual assembly line is created and maintained at a centralized location. Updates to the model are controlled and, when used, update information about the model to provide for up-to-date information of the progress of the development project.

In these and other aspects, therefore, apparatus, and an associated methodology, is provided for monitoring of a development project. An activity detector is positioned at a centralized location. The activity detector is configured to detect remote-site-generated information related to the development project. A modeler is configured to model the development project. A model formed by the modeler updateable by the remote-site-generated information. A display generator is configured to generate display indicia associated with the model. The display indicia is usable remote from the centralized location.

A more complete appreciation of the present invention to the scope thereof can be obtained from the accompanying drawings that are briefly described below, the detailed description of the presently preferred embodiments of the present invention, and the appended claims.

### BRIEF DESCRIPTION OF THE DRAWINGS

FIG. 1 illustrates a functional block diagram that identifies work-site locations and a centralized location at which the Virtual Assembly Line for Unified Engineering (V.A.L.U.E.) of an embodiment of the present invention is created and maintained.

FIG. 2 illustrates a data model display generated pursuant to operation of an embodiment of the present invention.

FIG. 3 illustrates a logical view that demonstrates correlation between additional displays, a portfolio view and a delivery view, that are generated pursuant to an embodiment of the present invention.

FIG. 4 illustrates a roadmap view of the portfolio categorization components generated pursuant to operation of an embodiment of the present invention.

FIG. 5 illustrates a representation of a decomposition of one of the components of the display shown in FIG. 3.

FIG. 6 illustrates a representation, similar to that shown in FIG. 5, but here of the decomposition of another one of the components shown in the display illustrated in FIG. 3.

FIG. 7 illustrates a method flow diagram representative of the method of operation of an embodiment of the present invention.

### DETAILED DESCRIPTION

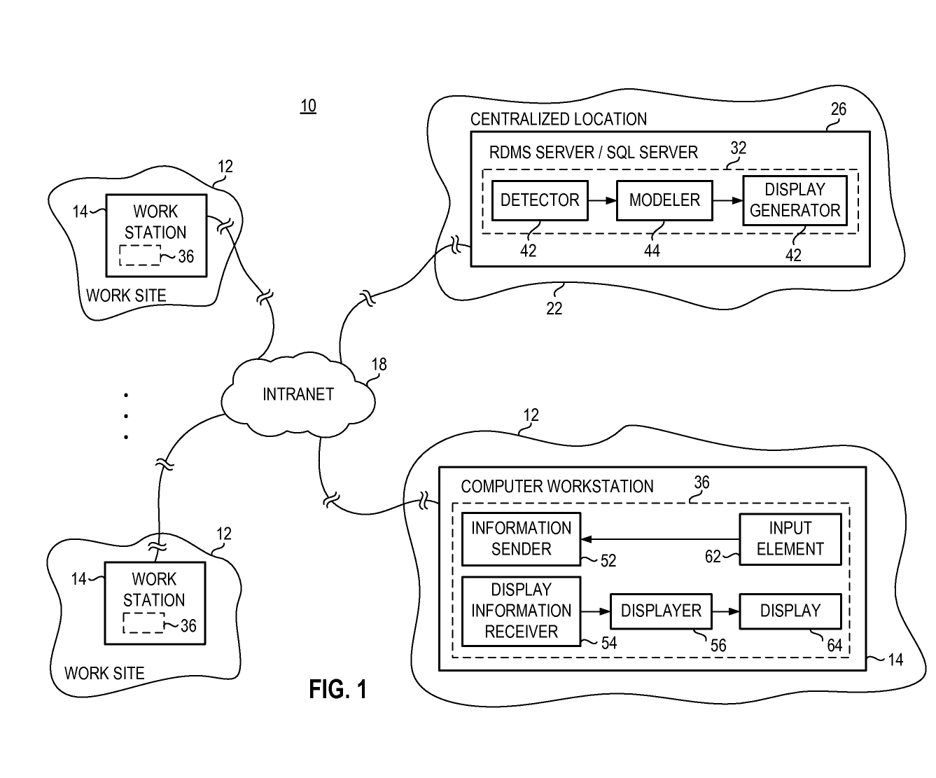

Referring first to FIG. 1, an arrangement, shown generally at 10, illustrates an exemplary collection of work sites 12 having processing devices, such as computer work stations 14 that are network-connected, here by way of the intranet 18, or other packet data network. A centralized location 22 provides for connections with the network 18, thereby to permit controlled access of the devices 14 at the remote work sites 12 to a processing device, at the centralized location. Here, the centralized location is shown to include a Relational Database Management System (RDMS) device, here an SQL (Structured Query Language) server 26. The centralized location also supplies the application services to manage the content being displayed at the workstations. This content is managed through common industry protocols and web enabled services.

The work sites 12 are representative of disparately-positioned work sites of a development organization that is encharged with development tasks pursuant to a development project. In the exemplary implementation, the development project comprises a computer-services-based project, involving, e.g., the creation of source code operable as functional entities on one or more computer workstations. More generally, the development project is any type of development project, particularly a project whose end-product is something other than a mass-produced hard good, such as a hard good created on an assembly line.

As noted previously, a significant problem that is regularly associated with such development projects pertains to the difficulty in tracking progress of the project. While the progress of formation of an assembly-line-created hard good is relatively easy to track, the tracking of the progress of a development project that is not implemented by way of an assembly line or the like, is much more difficult. Development tasks carried out by personnel at disparate work sites are sometimes documented in different manners, documented only locally, or otherwise inadequately documented in manners to permit accurate tracking of the progress of the development project.

An embodiment of the present invention provides a mechanism by which better to monitor the progress of a development project. The embodiment of the present invention is also useable for all aspects of the development, including marketing and initial planning of the project.

An apparatus 32 of an embodiment of the present invention is provided at SQL Server 26. Additional apparatus 36 is embodied elsewhere, here at one or more processing devices 14 positioned at the remote work sites 12. The apparatus 32 and 36 are functionally represented, formed of functional entities that are implementable in any desired manner including, for instance, by algorithms executable by processing circuitry, hardware devices, or combinations thereof. Additionally, while an exemplary implementation, the apparatus 32 is shown to be embodied at the server and the apparatus 36 is shown to be embodied at a computer workstation 14, in other implementations, the functional entities forming the respective apparatus are physically implemented at additional device, such as distributed amongst a plurality of devices.

The apparatus 32 forms an optimized manufacturing process used for modeling of a virtual assembly line. The model includes an activity detector 42, a modeler 44, and a display generator 46. And, the apparatus 36 is shown to include an information sender 52, a display indicia receiver 54, and a display device 56. An input element 62 and a display device 64 are also positioned at, and form parts of, the processing device 14 positioned remote from the centralized location. Processing devices are also positionable, if desired, at the centralized location 22, operable in manners analogous to the processing devices positioned at the remote work sites. The apparatus 32 and 36 together provide for the planning, designing, building, and modifying an optimized manufacturing process.

In operation, the modeler 44 operates to create and maintain a model of the development project. The model configures an optimized manufacturing process and is of any various configurations and complexities. Most generally the model forms a work plan that identifies the work tasks of the development project to provide for the tracking of progress towards completion of the various tasks of the development project. The tasks are categorized into groups, sequences, and conditional execution to form a virtual assembly line. The virtual assembly line models actual flows at production facilities. Updates to the progress of the development project, or its individual tasks, are detected by the activity detector 42. The updates are provided, e.g., by personnel operating at the remote work sites. Additional updates are, if needed, also provided locally, including, e.g., updates that identify changes, additions, or amendments to the development project.

Data pertaining to the model, which forms the optimized manufacturing process, and updates thereto are centrally maintained at the SQL server, thereby to provide a single, centralized monitoring device that monitors the progress of the development project. The model is usable additionally prior to commencement of a development project, e.g., to identify needed resources and to monitor various development-project alternatives. The optimized manufacturing process also thereby provides a manner by which to market a development project and to identify and illustrate alternative implementations of a development project.

The display generator utilizes information associated with, or formed by, the tasks, groups of tasks, decompositions of tasks, etc. provided by the modeler 44. The display generator generates display information of a type that is permitting of its display in human perceptible form. The tasks and sub-tasks, each of which can be decomposed into components, are displayable on an adhoc basis by authorized users. Information related to the tasks and sub-tasks and the components thereof are stored and selectably updated. And, displays are generated related to any of various levels of views, including at the component level to provide a viewer with appropriate information.

The apparatus 32 operates, in the exemplary implementation, in conjunction with the apparatus 36 positioned at one or more processing devices 14. The information sender of the apparatus 36 generates, updates, and other information that are communicated to the centralized location. If properly authenticated and otherwise authorized, and if the task, or sub-task to which the information pertains is accepting of the information or updates, the information sent by the information sender is provided by the detector 42 and used to update data that is associated with any of the various virtual assembly line components. And, the display information generated by the display generator 46 is provided, such as responsive to a request, to a processing device 14 and detected by a receiver 54 and caused by a displayer 56 to be displayed upon a display 64. The request is generated, for instance, through user actuation of the input element 62 on an ad hoc basis. Due to the positioning of the apparatus 32 at a centralized location and due to the controlled access to the contents of the data base maintained thereat, and used to form development project models, controlled updates related to the progress of the completion of the development project are provided and maintained. Problems associated with nonuniform updates, intermittent updates, or no updates are less likely to occur. Improved tracking of the status of a service-based development process is provided. And, through such improved tracking, if progress on the development deviates from plan, per notice of the deviation is facilitated, permitting corrective action more quickly to be made.

Additionally, as a byproduct of operation of the apparatus 32, workflow catalog information is generated. The workflow catalog information is also selectably provided to remote processing devices. The workflow catalog information is operated upon by a workflow engine resulting in the workflow catalog information also to be displayable at the display 64 at a processing device 14.

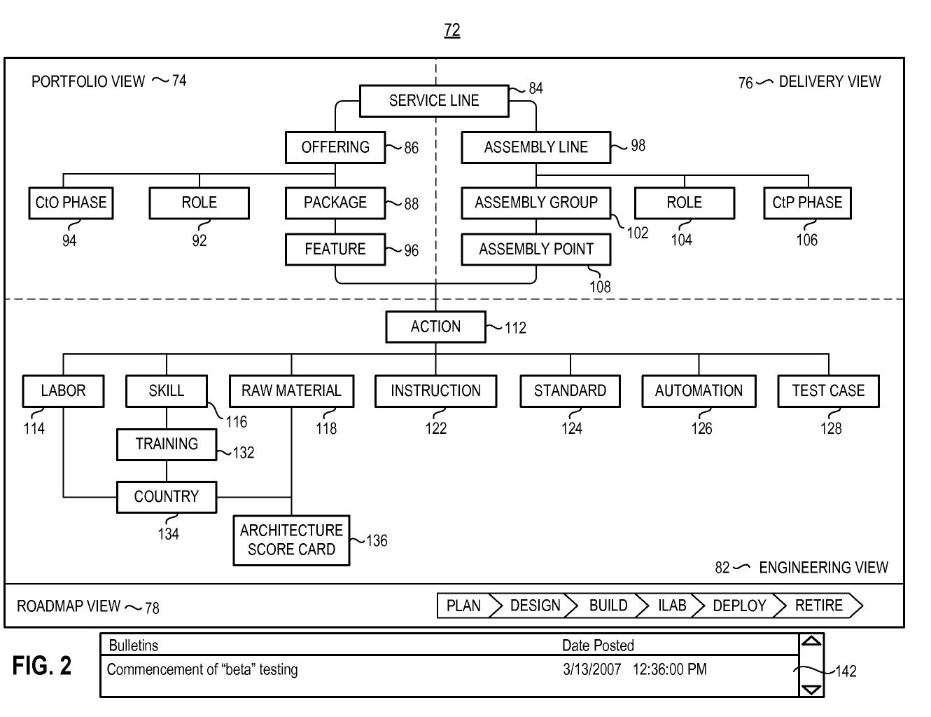

FIG. 2 illustrates a display 72, exemplary of a display displayable at a user display 64 during operation of an embodiment of the present invention. The display 72 comprises a data model view that, in one implementation, forms a home screen. The display 72 depicts components of the tool, a virtual assembly line for unified engineering tool, and graphically illustrates the manner for which the components are logically linked to one another.

The display 72 provides links that, when taken lead to subsequent displays. Here, the display identifies a portfolio view 74, and a delivery view 76. The portfolio view is also identified as a roadmap view 78, and the delivery view is also identified as an engineering view 82.

The flow chart identifications are also displayed on the display, including a service link 84, an offering link 86, a package link 88, a role link 92, a CtP phase 94, a feature length 96, and an assembly line link 98, an assembly group 102, a roll link 104, a CtP phase 106, an assembly point 108, and an action link 112. Additionally, under the action link are labor 114, skill 116, raw material 118, instruction 122, standard 124, automation 126, and test case 128 links. Further, a training link 132, a country link 134, and an architecture score card link 136 are shown. The display 72, in the exemplary implementation, further includes a screen segment that lists development-project and other, bulletins. Here a bulletin 142 is listed, titled as a commencement of “beta” testing. The data model here further supports the product life cycle used by a developing organization to create and manage a service. That is to say, the developing organization's concept-to-offering development cycle is identified by way of the home page.

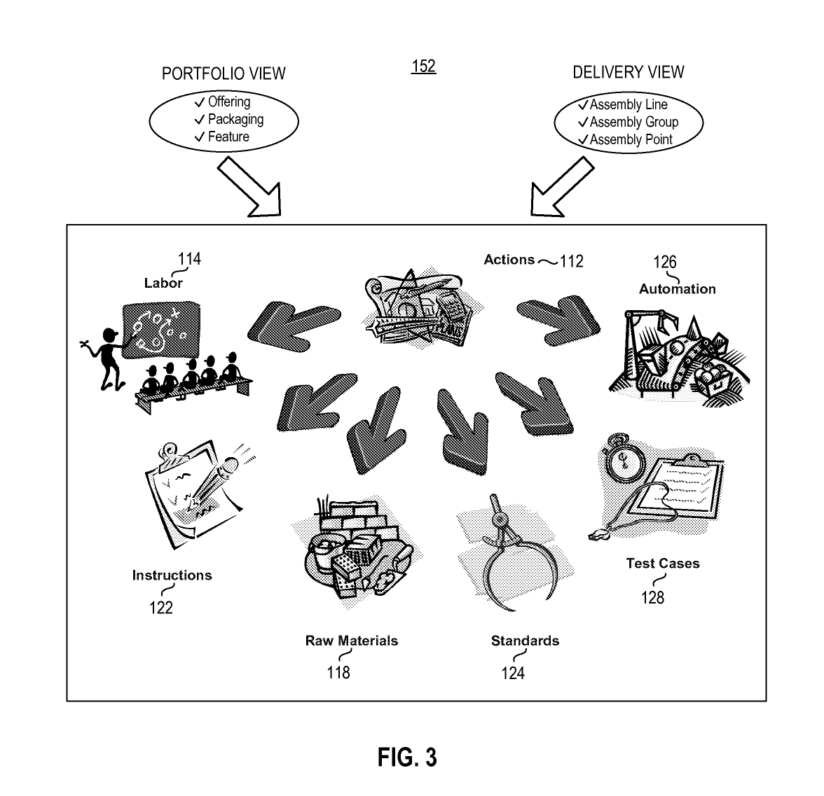

FIG. 3 illustrates a logical representation 152 that demonstrates the correlation between a portfolio view and a delivery view. The portfolio view is amenable as a sales view and the delivery view is amenable as a manufacturing view. The portfolio view is used when viewing a task of a process or a decomposition thereof into components in terms of an offering, package, or feature perspective. And, the delivery view is used when viewing a task, or a decomposition thereof, in terms of an assembly line, group, or point perspective. The display 152 shows the action link 112 together with the labor link 114, raw material link 118, instruction link 122, standards link 124, test case link 128, and automation link 126. Links taken using a portfolio view to an offering, package, and feature information while links taken from the delivery view provide information related to an assembly line, assembly group, and assembly point associated with the development project.

As noted previously, limited access is permitted to access and to update the data at the SQL server 26 (shown in FIG. 1) at which the apparatus 32 is maintained. That is to say, change management is provided. Updates to the data are restricted. For instance, updates are restricted based upon role, team, and user. Additionally, each task, or subtask of the development project has associated therewith a status. Depending upon the status of the task or subtask, updates are permitted, or restricted. For instance, once an assembly line is classified as “delivery ready”, all components associated with the assembly line are locked, restricting further updates thereto.

An architecture score card is further provided. Raw materials, e.g., technology-based raw materials, that are to be used pursuant to the development project, are assessed for business value. The assessment is conducted relative to the manner in which the raw material is used (a use case) using categories and attributes. The assessment enables an objective comparative analysis of different raw materials, hardware and software, usable pursuant to a development project.

Additionally, by providing a roadmap view, a user is able to see existing and future products associated with a development project in terms of their underlying reference architecture and chronological timeline for development.

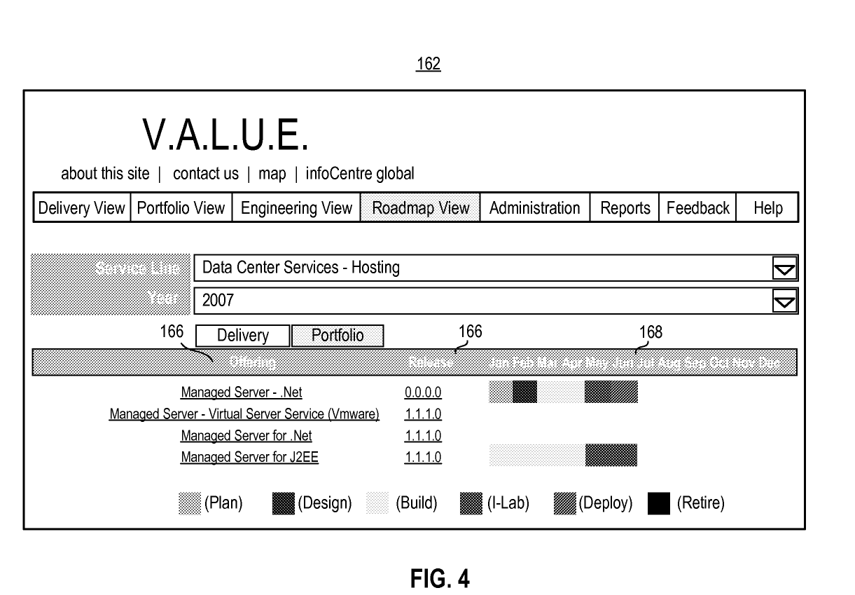

FIG. 4 illustrates an exemplary display 162, also generated pursuant to operation of an embodiment of the present invention. Here, a roadmap view, taken from a portfolio perspective, is provided. The view includes a table with listing categories of an offering 164, a release number 166, and a timeline 168. The offering column includes a number of entries, the release numbers associated therewith are identified in the column 166 and the date associations are indicated in corresponding entries in the column 168.

Each raw material undergoes an evolution from general availability to end-of-support. Information associated with this evolution is important for effective release planning and management. Through operation of an embodiment of the present invention, this information is captured, and displayable, integrated into the release, planning, and management activities of a service.

In operation, an embodiment of the present invention provides a catalyst and an enabler for accelerating the re-use of engineering collateral. The capability is provided by requiring an infrastructure engineered to normalize the manufacturing process into stand-alone actions and then sequencing and grouping the actions together as logical units of work. The logical units of work are building blocks for the workflow engine, referenced above. The actions are accompanied by their corresponding instructions, labor, raw materials, standards, test cases, and automation, easily reusable in the manufacturing process for other products.

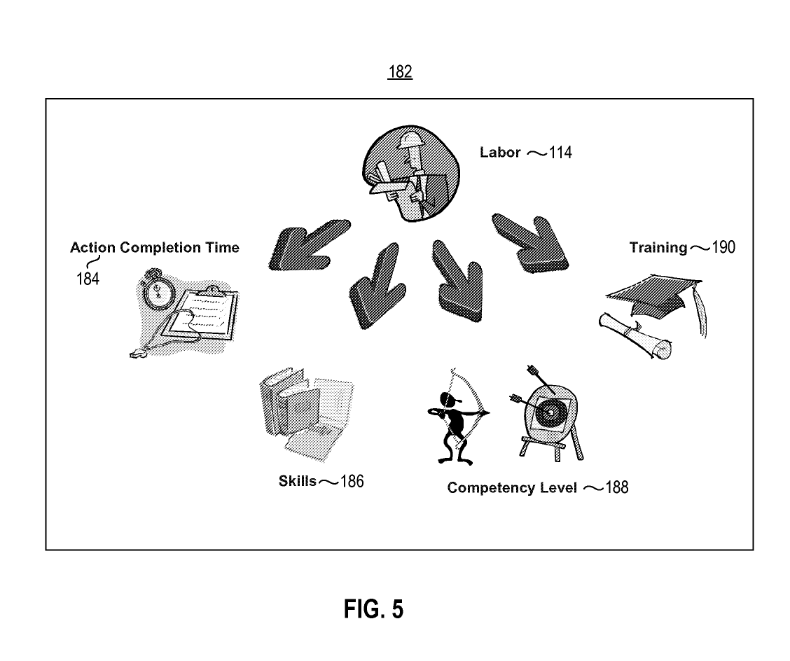

FIG. 5 illustrates an exemplary logical view 182, representative of a decomposition of the labor component 114. The labor component is decomposed here into an action completion time 184, skills 186, competency level 188, and training 190. The subcomponents of the labor component are used, e.g., pursuant to development of a bill of labor. The bill of labor is used in a cost model. This information is used, e.g., by a service delivery team to create workforce strategies.

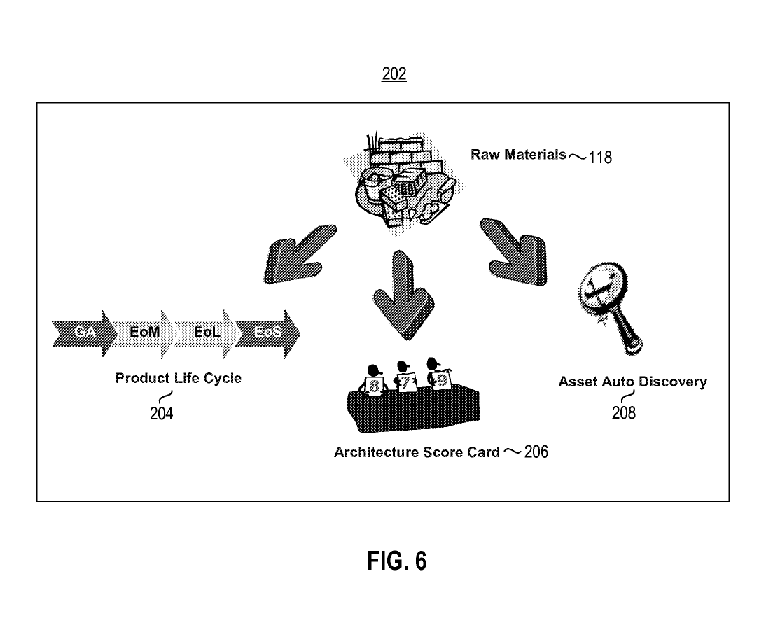

FIG. 6 illustrates a logical view 202 representative of the decomposition of the raw materials component 118. Here, a product life cycle 204, an architecture score card 204, and an asset auto discovery subcomponent are illustrated. These subcomponents are used pursuant to development of a Bill of Materials (BoM). The bill of materials is used in the development of a cost model. This information is used additionally, e.g., for developing technology refresh strategy through utilization of the product lifecycle data that includes end of marketing, end of life, and end of support data. The architecture score card provides a fact-based and objective set of metrics to provide product comparisons. The asset auto discovery is used to identify valid asset information. Personnel are required to acknowledge and document which asset auto discovery routine is used to acquire and manage an automated inventory. This data is used pursuant to all configuration management databases.

In exemplary flow methodology, the tool is first authenticated. Once authenticated, a desired operation is selected, and then performed. And, once performed, results of the operation are obtained.

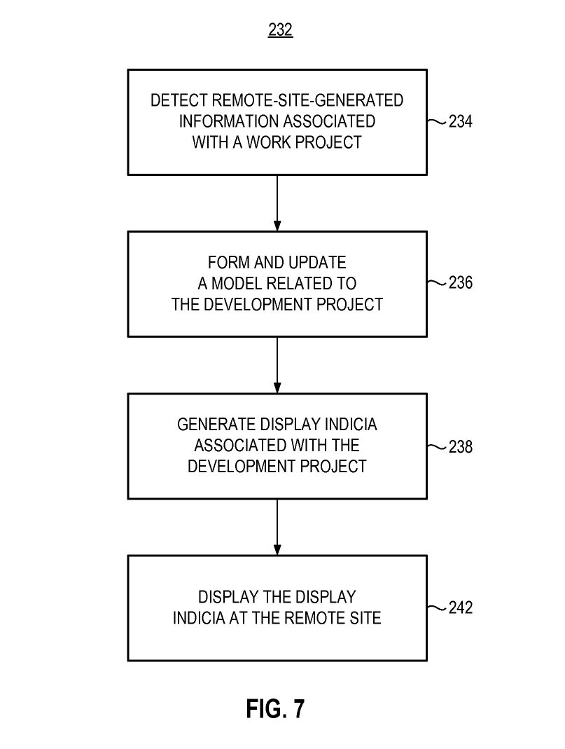

FIG. 7 illustrates a method flow diagram, shown generally at 232, representative of the method of operation of an embodiment of the present invention. The method facilitates monitoring of a development project. First, and as indicated by the block 234, remote-site-generated information related to the development project is detected. Then, and as indicated by the block 236, a model is formed or updated by the remote-site generated information. Then, and as indicated by the block 238, display indicia associated with the model is generated.

Thereafter, such as in response to a request for display information, the display information is provided, indicated by the block 242 to a remote location and, as indicated by the block 234, displayed thereat.

Thereby, an improved manner is provided by which to plan, model, and monitor a development project. Centralization of storage of data associated with the development project is provided, and access to the centrally stored data is made pursuant to various aspects of the development project.

The previous descriptions are of preferred examples for implementing the invention, and the scope of the invention should not necessarily be limited by this description. The scope of the present invention is defined by the following claims.

What is claimed is:

1. Apparatus for facilitating development of a development project in terms of a virtual assembly line, said apparatus comprising:
an activity detector positioned at a centralized location and configured to detect remote site-generated information related to the development project;
a modeler configured to model the development project, a model formed by said modeler updatable by the remote-site-generated information; and
a display generator configured to generate display indicia associated with the model, the display indicia useable remote from the centralized location.

2. The apparatus of claim 1 wherein the centralized location at which said activity detector is positioned comprises a centralized database of an SQL server.

3. The apparatus of claim 1 wherein the remote-site generated information comprises work-site generated information.

4. The apparatus of claim 1 wherein the remote-site generated information is related to a computer-related development project.

5. The apparatus of claim 1 wherein said modeler is further configured to form workflow catalog information that is configurable into a workflow catalog.

6. The apparatus of claim 1 wherein the display indicia comprises display indicia configurable into a data model display.

7. The apparatus of claim 1 wherein the display indicia comprises display indicia configurable into a portfolio view display.

8. The apparatus of claim 1 wherein the display indicia comprises display indicia configurable into a delivery view display.

9. The apparatus of claim 1 wherein the model formed by said modeler is updateable by selected ones of the remote-site-generated information.

10. The apparatus of claim 9 wherein the model formed by said modeler comprises model component parts and wherein the model component parts are individually selectably updateable.

11. The apparatus of claim 1 wherein the display indicia is useable to monitor the development project.

12. The apparatus of claim 1 wherein the model is further configured to identify bill of labor information.

13. The apparatus of claim 1 wherein the model further configured to identify bill of material information.

14. A method for facilitating development of a development project, said method comprising:
detecting, at a centralized location, remote-site-generated information related to the development project;
modeling the development project, a model formed by said modeling updateable by the remote-site-generated information; and
generating display indicia associated with the model, the display indicia useable remote from the centralized location.

15. The method of claim 14 wherein the display indicia comprises data model display indicia.

16. The method of claim 14 wherein the display indicia comprises portfolio view display indicia.

17. The method of claim 14 wherein the display indicia comprises delivery view display indicia.

18. The method of claim 14 further comprising forming a workflow catalog information that is configurable into a workflow catalog.

19. The method of claim 14 wherein said modeling is performed at an SQL server.

20. Apparatus for facilitating development of a development project, said apparatus comprising:
a sender configured to send remote-site-generated information related to the development project;
a receiver configured to receive display indicia associated with a model of the development project, the model of the development project formed using the remote-site-generated information; and
a displayer configured to display the display indicia.
